(19) United States
(12) Patent Application Publication
(10) Pub. No.: US 2007/0056255 A1
(43) Pub. Date: Mar. 15, 2007

(54) Cartridge filter rotating system

(76) Inventor: Juris Terauds, Olivenhain, CA (US)

Correspondence Address: JURIS TERAUDS, 3319 LONE JACK ROAD, OLIVENHAIN, CA, 92024, US

(21) Appl. No.: 11/222,396

(22) Filed: Sep. 9, 2005

(51) Int. Cl. B01D 46/00

(52) U.S. Cl. 55/400

(57) ABSTRACT

The present invention relates to a shop vacuum cleaner cartridge filter rotating system, consisting of a turbine mount, a turbine impeller blade and a cartridge filter mount, assembled on an axle. The suction air stream through the shop vacuum cleaner and through the turbine rotates the cartridge filter on the filter mount of the filter rotating system, creating centrifugal force on the outer surface of the rotating cartridge filter, which inhibits particles carried by the air from settling on the filter. This rotating action of the filter keeps the filter relatively clean, with air passage through the filter unobstructed, which prolongs the optimum function of the filter and reduces the frequency of necessary filter service. The shop vacuum cleaner cartridge filter rotating system can readily be built into a new vacuum cleaner or retrofitted in existing vacuum cleaners.

### BACKGROUND OF THE INVENTION

The present invention relates to vacuum cleaners. In particular, the present invention relates to vacuum cleaners using cartridge filters, such as the canister shop vacuum cleaners used for sucking dirt, debris and material particles from floors and work areas.

Shop vacuum cleaners with round cartridge filters are ubiquitous in private homes, shops and institutions. As they are operated with a clean filter, the airflow through the filter is not obstructed by foreign particles, the power and volume of the suction of the vacuum cleaner at the intake nozzle is adequate. However, quickly, with continuous use the outer surface of the filter accumulates particles, such that the airflow is blocked and decreased with the vacuum cleaner loosing suction power and airflow volume at the intake. Each time the filter gets obstructed by particles of debris suction power decreases and the filter has to be cleaned or replaced. Consequently, operation of the vacuum cleaner has to be interrupted frequently with time lost and energy expended replacing or cleaning the filter. Further, this untimely replacement of the filter adds to the cost of operating the vacuum cleaner. Prior art does not address the above-described round cartridge vacuum filter clogging problems adequately.

To avoid the frequent interruption of the round cartridge vacuum cleaner operation and to reduce the cost of operating the vacuum cleaner, the particles being carried by the air into the vacuum cleaner must be kept from landing and building up on the filter surface. This can be accomplished by rotating the filter during operation, such that the centrifugal force created at the surface of the filter, by its rotation, prevents particles from landing on the rotating surface of the filter.

Accordingly, it has been deemed desirable to develop a system for rotating the cartridge filter, such that the cartridge filter rotates while the vacuum cleaner is operating. Preferable is a cartridge filter rotating system that can be built in new vacuum cleaners or retrofitted in the thousands of vacuum cleaners now in use, at a low cost, and with advantageous overall results. The present art addresses exactly this problem with the novel shop vacuum cleaner cartridge filter rotating system invention.

### BRIEF SUMMARY OF THE INVENTION

According to the present invention, a novel shop vacuum cleaner cartridge filter rotating system is provided.

In accordance with the invention, a shop vacuum cleaner cartridge filter rotating system, which includes a turbine mount, a turbine impeller blade and a cartridge filter mount, assembled on an axle is provided. The cartridge filter mount is rotationally driven on the axle by the air passing the turbine impeller blade. The rotation of the cartridge filter mount, with the cartridge filter mounted thereon, creates centrifugal force at the surface of the filter, inhibiting particles, carried by the passing air, from landing on the surface of the filter.

It is therefore an object of the present invention to provide a vacuum cleaner cartridge filter rotating system, which when operated in a vacuum cleaner keeps the filter surface relatively free of particles. Further, it is an object of the present invention to provide an inexpensive vacuum cleaner cartridge filter rotating system for new vacuum cleaners. Still further, it is an object of the present invention to provide an inexpensive vacuum cleaner cartridge filter rotating system for retrofitting old vacuum cleaners. And still further, to provide a vacuum cleaner cartridge filter rotating system, which can be installed with minimum effort and at a low cost. These and other objects will become increasingly apparent to those skilled in the art by reference to the drawings and further explanations.

### DESCRIPTION OF DRAWINGS OF THE INVENTION

The accompanying drawings are incorporated in and constitute a part of this description of the invention, they serve to example the principles of this invention.

FIG. 1 is a side cross-sectional view along the vertical axis of the cartridge filter rotating system in accordance with the present invention.

FIG. 2 is a top plan view of the cartridge filter rotating system turbine mount.

FIG. 3 is a top plan view of the cartridge filter rotating system turbine impeller blade.

FIG. 4 is a top plan view of the cartridge filter rotating system cartridge filter mount.

FIG. 5 is a top plan view of the cartridge filter rotating system turbine impeller blade fixed to the top of the cartridge filter mount.

### DETAILED DESCRIPTION OF THE INVENTION

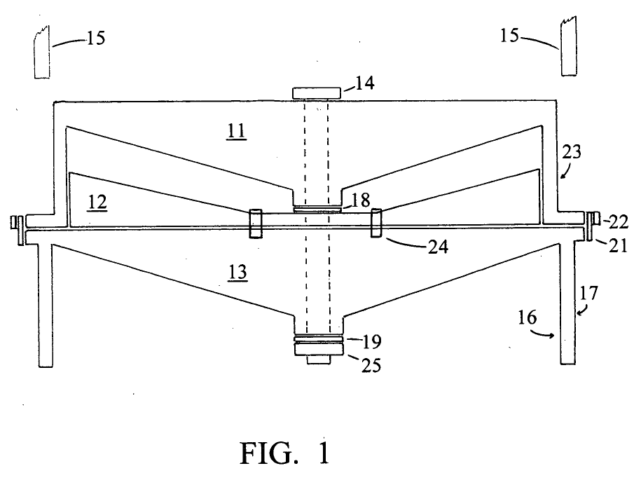

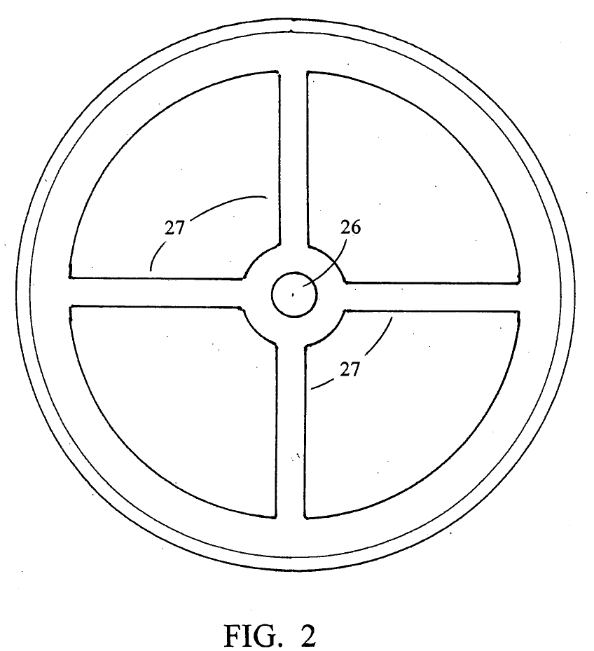

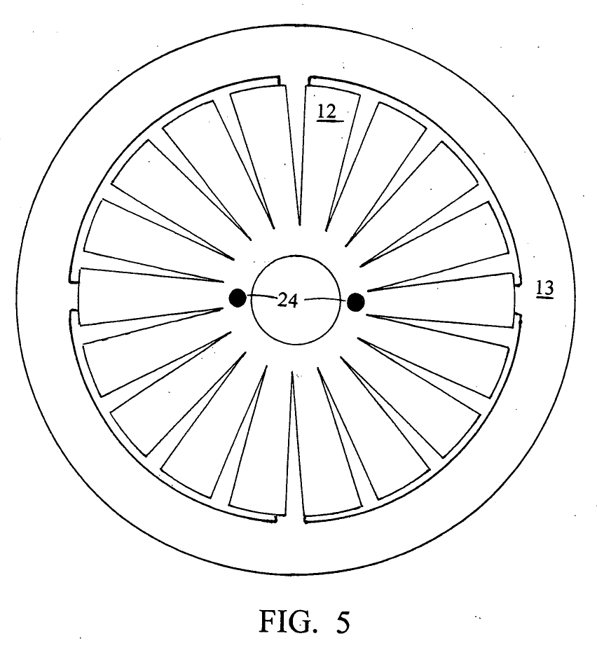

Referring now to the FIGURES, the showings are for purposes of illustrating preferred embodiments of the invention only and not for limiting the same. FIG. 1 illustrates a side cross-section along the vertical axis of the assembled parts of the cartridge filter rotating system, while FIGS. 2, 3, 4 and 5 show the cartridge filter rotating system parts from a top plan form perspective. Looking at FIG. 1, we can see the axle l4 pressed into the axle housing 26 (FIG. 2) of the cartridge filter rotating system turbine mount 11, such that it is held firm. The cartridge filter rotating system turbine impeller blade 12, is fixed in place by the turbine blade fasteners 24, at the upper cartridge filter mount bearing 18. The lower cartridge filter mount bearing 19, is held against the cartridge filter rotating system cartridge filter mount 13, on the axle 14, by the axle fastener 25.

The bearings 18 and 19 permit low resistance rotation of the cartridge filter rotating system turbine impeller blade 12 with the cartridge filter rotating system cartridge filter mount 13, on the axle 14, held in place by the cartridge filter rotating system turbine mount 11.

The regular filter cage is mounted in the filter cage interface 16 of the cartridge filter rotating system cartridge filter mount 13, in the same manner that the filter cage would be mounted in the vacuum cleaner filter cage mount 15, when the cartridge filter rotating system is not used. Further, the cartridge filter is mounted on the filter cage and the cartridge filter interface 17 of the cartridge filter rotating system cartridge filter mount 13.

To prevent dust particles from contaminating the air stream which has passed through the filter, the narrow space between the cartridge filter rotating system cartridge filter mount 13, and the cartridge filter rotating system turbine mount 11, is covered with a low friction dust seal strip 21, held in place on the cartridge filter rotating system turbine mount 11, by the elastic dust seal strip holder 22. The low friction dust seal strap does not materially restrict the rotation of the cartridge filter rotating system cartridge filter mount 13, driven by the air stream passing through the cartridge filter rotating system turbine impeller blade 12.

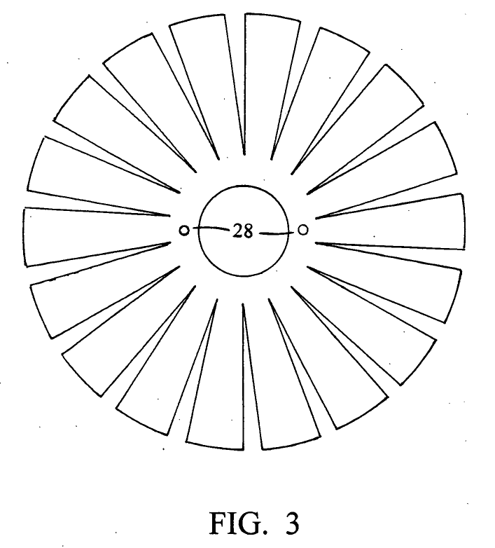

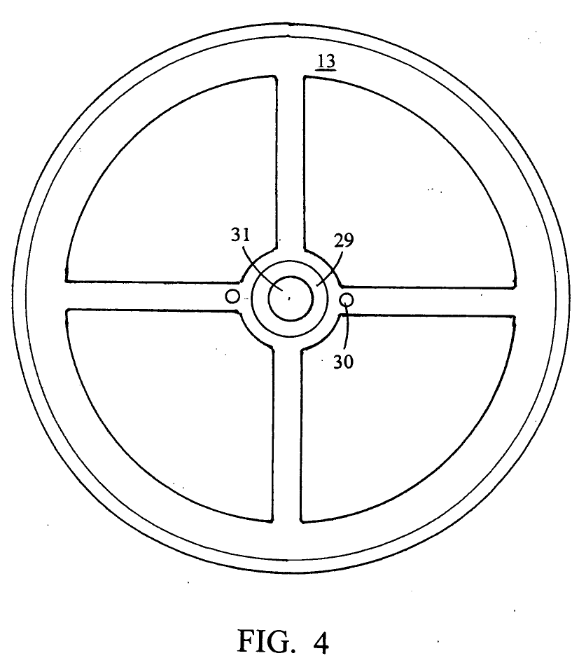

Referring to FIG. 2, the top view of the cartridge filter rotating system turbine mount 11, shows the axle supports 27, with the axle housing 26. Referring to FIG. 3, the top view of the cartridge filter rotating system turbine impeller blade 12, is illustrated with its holes 28 for attachment to the cartridge filter rotating system cartridge filter mount 13. While FIG. 4 shows a top view of the cartridge filter rotating system cartridge filter mount 13, with its axle passage 26, top bearing 29, cartridge filter rotating system turbine impeller blade 12 mounting holes 30, and axle supports 31 of the cartridge mount 13.

In summary then, for the operation of a vacuum cleaner with the novel invention, the cartridge filter rotating system is installed in the vacuum cleaner suction unit, to replace the exact position of the cartridge filter cage. The cartridge filter cage is installed in the cartridge filter mount 13, and the cartridge filter is installed on top of the filter cage and the cartridge filter mount 13 at the cartridge filter interface 17. At this point the vacuum cleaner suction unit can be placed on the vacuum cleaner canister, ready for operation.

The invention has been described with detailed reference to the preferred embodiments. Obviously there will occur, possible modifications and alterations, to others reading and understanding the preceding detailed description. It is intended that the invention be construed as including all such possible modifications and alterations insofar as they come within the scope of the claims or the equivalents thereof.

What is claimed is:

1. A vacuum cleaner cartridge filter rotating system for rotating cartridge vacuum cleaner filters of vacuum cleaners using round cartridge filters.

2. A vacuum cleaner cartridge filter rotating system as claimed in 1 wherein the vacuum cleaner cartridge filter rotating system may be attached to the existing filter and cage attachment mount as a retrofit to vacuum cleaners using cartridge filters.

3. A vacuum cleaner cartridge filter rotating system as claimed in 1 wherein the vacuum cleaner cartridge filter rotating system has its own rotating propulsion device.

4. A vacuum cleaner cartridge filter rotating system as claimed in 1 wherein the vacuum cleaner cartridge filter rotating system has its own impeller turbine driven by the air stream sucked through the vacuum cleaner.

5. A vacuum cleaner cartridge filter rotating system as claimed in 1 wherein the vacuum cleaner cartridge filter rotating system accommodates the regular existing filter cage and filter.

6. A vacuum cleaner cartridge filter rotating system as claimed in 1 wherein the vacuum cleaner cartridge filter rotating system is built into new vacuum cleaners.

7. A vacuum cleaner cartridge filter rotating system comprising:
an upper casing which mounts to the vacuum suction unit,
a cartridge cage and filter mount rotationally attached to the upper casing mount, and
a device to propel the cartridge cage and filter mount about the upper casing mount.

8. A vacuum cleaner cartridge filter rotating system capable of rotating a cartridge vacuum cleaner filter.
